(19) United States
(12) Patent Application Publication
(10) Pub. No.: US 2014/0023417 A1
(43) Pub. Date: Jan. 23, 2014

(54) IMAGE FORMING APPARATUS THAT DISCHARGES SHEETS TO POST-PROCESSING APPARATUS, AND IMAGE FORMING SYSTEM

(71) Applicant: Canon Kabushiki Kaisha, Tokyo (JP)

(72) Inventor: Toshiyuki Miyake, Abiko-shi (JP)

(21) Appl. No.: 13/943,017

(22) Filed: Jul. 16, 2013

(30) Foreign Application Priority Data
Jul. 18, 2012 (JP) 2012-159601

(51) Int. Cl. G03G 15/00

(52) U.S. Cl. CPC G03G 15/6582
USPC 399/407

(57) ABSTRACT

An image forming apparatus that has a post-processing apparatus connected thereto and is capable of achieving the same level of improvement of sheet output productivity without buffering as that achieved with buffering, and an image forming system. The image forming apparatus includes sheet feeders containing sheets and a printer which forms an image on a sheet. The post-processing apparatus performs post processing on the sheets on which image formation has been performed. When double-sided printing for forming images on both sides of a sheet is performed for a plurality of sheets, a sheet circulation method in double-sided printing is selected between “alternate circulation” and “block circulation” according to information of post processing to be performed on the sheets, which is designated in a print job.

### BACKGROUND OF THE INVENTION

1. Field of the Invention

The present invention relates to an image forming apparatus, such as a copy machine or a printer, that forms an image on a conveyed sheet, and discharges the sheet to a post-processing apparatus, and to an image forming system.

2. Description of the Related Art

Conventional image forming systems are known in which a post-processing apparatus is connected to the downstream side of an image forming apparatus in the sheet conveying direction. The post-processing apparatus performs post processing, such as stapling or punching, on sheets conveyed from the image forming apparatus, which have images formed thereon.

Further, a post-processing apparatus has been proposed which is configured to sequentially stack sheets received from an image forming apparatus on an intermediate tray (hereafter referred to as the “processing tray”) disposed at a location upstream of a stacking tray, and perform post processing, such as stapling or saddle-stitching, on a bundle of the sheets stacked on the processing tray after all of sheets forming a booklet have been stacked thereon. The sheet bundle which has been subjected to the post processing on the processing tray is discharged from the processing tray onto the stacking tray.

Further, there has been proposed an image forming apparatus which improves sheet output productivity by performing processing for overlaying a plurality of subsequent sheets one upon another (hereinafter referred to as “buffering”) while performing post processing on a preceding sheet bundle (see e.g. Japanese Patent Laid-Open Publication No. H09-48545). More specifically, a sheet is wrapped around a buffer roller disposed at a location upstream of the processing tray where post processing is to be performed, and then the buffer roller is stopped and held in a wait state. Then, the buffer roller is driven again when a subsequent sheet arrives at a location in which it overlays the subsequent sheet on the wrapped sheet. As described above, by overlaying a predetermined number of sheets, which form a subsequent sheet bundle, one upon another, whereby the sheets forming the subsequent sheet bundle are prevented from being discharged onto the processing tray while post processing is being performed on a preceding sheet bundle on the processing tray. As a result, it is possible to perform post processing on each sheet bundle without increasing an interval at which sheets are conveyed in the image forming apparatus, which prevents the sheet output productivity from being lowered.

However, in the above-mentioned conventional image forming apparatus, to perform buffering of sheets of a large size, such as A3 sheets, or sheets of a full-bleed size, such as SRA (supplementary raw format A) sheets, it is inevitable that the size and manufacturing costs of the apparatus are increased. Therefore, some image forming apparatuses, which are compact in size and intended to be installed in offices, are configured to be capable of performing buffering of only small-sized sheets, or some of them are not originally configured to perform buffering. If a post-processing apparatus performs post processing, such as stapling or saddle-stitching, on a sheet bundle on which images have been formed by such an image forming apparatus as described above, the sheet output productivity is lowered.

Further, even when the image forming apparatus is configured to be capable of performing buffering of large-sized sheets, the image forming apparatus sometimes cannot perform buffering of special sheets, such as coated paper or thick paper, due to misalignment caused by sheets which are stuck to each other, image flaws caused by friction between a conveying path and each sheet due to an increased rigidity of the sheet, or other like problems. If the post processing as described above is performed in this case, the sheet output productivity is similarly lowered.

### SUMMARY OF THE INVENTION

The present invention provides an image forming apparatus that has a post-processing apparatus connected thereto and is capable of achieving the same level of improvement of sheet output productivity without buffering as that achieved with buffering, and an image forming system.

In a first aspect of the present invention, there is provided an image forming apparatus comprising an accommodation unit configured to accommodate sheets, an image forming unit configured to form an image on a sheet, a conveying unit configured to convey a sheet from the accommodation unit to the image forming unit so as to form an image on a first side of the sheet, and to further convey the sheet on which the image has been formed on the first side to the image forming unit a second time so as to form an image also on a second side, which is different from the first side, of the sheet, an acquisition unit configured to acquire information of post processing to be executed by a post-processing apparatus which is connectable to the image forming apparatus, a control unit configured, in the case that images are to be formed on both of first and second sides of each of a plurality of sheets, to cause a double-sided image formation process to be executed by one of a first double-sided image formation process and a second doubled-sided image formation process, the first double-sided image formation process repeatedly performing continuous execution of image formation on the first side of each of a first predetermined number of sheets conveyed from the accommodation unit, and subsequent continuous execution of image formation on the second side of each of the first predetermined number of the conveyed sheets each having image formation performed on the first side thereof, and the second doubled-sided image formation process performing continuous execution of image formation on the first side of each of a second predetermined number of sheets conveyed from the accommodation unit, thereafter performing alternate execution of image formation on the second side of each of the conveyed sheets each having image formation performed on the first side thereof and image formation on a first side of each of different sheets conveyed from the accommodation unit, and thereafter performing continuous execution of image formation on the second side of each of the second predetermined number of sheets having image formation performed on the first side thereof, and a selection unit configured, in the case that double-sided image formation processing is to be executed, to select one of the first double-sided image formation process and the second double-sided image formation process based on the information of post processing acquired by the acquisition unit.

In a second aspect of the present invention, there is provided an image forming system comprising an accommodation unit configured to accommodate sheets, an image forming unit configured to form an image on a sheet, a conveying unit configured to convey a sheet from the accommodation unit to the image forming unit so as to form an image on a first side of the sheet, and to further convey the sheet on which the image has been formed on the first side to the image forming unit so as to form an image also on a second side, which is different from the first side, of the sheet, a post-processing unit configured to perform post processing on a sheet on which an image has been formed by the image forming unit, a control unit configured, in the case that images are to be formed on both of first and second sides of each of a plurality of sheets, to cause a double-sided image formation process to be executed by one of a first double-sided image formation process and a second doubled-sided image formation process, the first double-sided image formation process repeatedly performing continuous execution of image formation on the first side of each of a first predetermined number of sheets conveyed from the accommodation unit, and subsequent continuous execution of image formation on the second side of each of the first predetermined number of the conveyed sheets each having image formation performed on the first side thereof, and the second doubled-sided image formation process performing continuous execution of image formation on the first side of each of a second predetermined number of sheets conveyed from the accommodation unit, thereafter performing alternate execution of image formation on the second side of each of the conveyed sheets each having image formation performed on the first side thereof and image formation on a first side of each of different sheets conveyed from the accommodation unit, and finally performing continuous execution of image formation on the second side of each of the second predetermined number of sheets having image formation performed on the first side thereof, and a selection unit configured, in the case that the double-sided image formation process is to be executed, to select one of the first double-sided image formation process and the second double-sided image formation process based on the information of post processing to be executed by the post-processing unit.

According to the present invention, when double-sided printing is performed on a sheet, a sheet circulation method is selected between “alternate circulation” and “block circulation” according to a type of post processing to be performed on the sheet. This makes it possible to achieve the same level of improvement of sheet output productivity as that achieved with buffering, without depending on the configuration of the post-processing apparatus.

Further features of the present invention will become apparent from the following description of embodiments with reference to the attached drawings.

### BRIEF DESCRIPTION OF THE DRAWINGS

FIG. 1 is a view, partly in cross-section, of an image forming system to which an image forming apparatus according to one embodiment of the present invention is applied.

FIG. 2 is a detailed cross-sectional view of a finisher appearing in FIG. 1.

FIG. 3 is a plan view of the appearance of an operation side of a console unit appearing in FIG. 1.

FIGS. 4A to 4D are diagrams showing examples of a display screen displayed on a liquid crystal display section appearing in FIG. 3.

FIG. 5 is a block diagram of a controller that controls the overall operation of the image forming system shown in FIG. 1.

FIG. 6 is a block diagram of a finisher controller appearing in FIG. 5.

FIGS. 7A and 7B are diagrams showing double-sided printing using “alternate circulation” and double-sided printing using “block circulation”, respectively.

FIGS. 8A to 8D are diagrams showing states of conveyance of sheets by the double-sided printing using “alternate circulation”, respectively.

FIGS. 9A to 9D are diagrams showing states of conveyance of sheets by the double-sided printing using “block circulation”.

FIG. 10 is a flowchart of a circulation method selection process executed by a CPU of a CPU circuit unit of the image forming apparatus appearing in FIG. 1.

FIGS. 11A and 11B are diagrams showing double-sided printing using “alternate circulation” and double-sided printing using “block circulation”, in a case where a saddle stitching mode is designated, respectively.

### DESCRIPTION OF THE EMBODIMENTS

The present invention will now be described in detail below with reference to the accompanying drawings showing embodiments thereof.

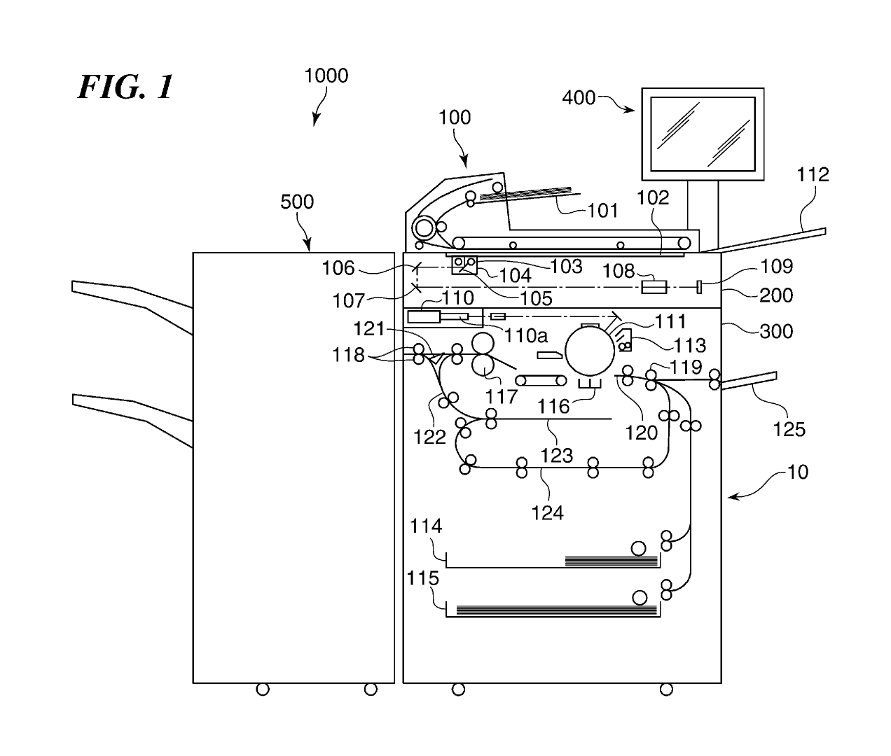

FIG. 1 is a view, partly in cross-section, of an image forming system 1000 to which an image forming apparatus according to an embodiment of the present invention is applied.

As shown in FIG. 1, the image forming system 1000 comprises an image forming apparatus 10 that forms an image on a sheet which is conveyed, and a finisher 500 which is a post-processing apparatus connected to a downstream side of the image forming apparatus 10 in a sheet conveying direction.

As examples of the image forming apparatus 10, there may be mentioned a copy machine, a facsimile machine, a printer, a multifunction peripheral as a combination of these, and so forth.

However, the image forming apparatus 10 is not limited to one of them, but any of them may be employed as the image forming apparatus 10.

The finisher 500 performs various kinds of post processing, including processing for sequentially introducing sheets discharged from the image forming apparatus 10 therein, aligning the plurality of introduced sheets, and binding the aligned sheets into one sheet bundle, punching for forming holes in a rear end of the sheet bundle, stapling for securing the rear end with staples, sorting, and non-sorting processing.

As shown in FIG. 1, in the present embodiment, the image forming apparatus 10 and the finisher 500 are constructed as units separate from each other. The finisher 500 can be selected as an optional unit to be connected to the image forming apparatus 10, and hence the image forming apparatus 10 can also be singly used. However, these are not limiting as the image forming apparatus 10 and the finisher 500 may be integrally constructed.

The image forming apparatus 10 includes an image reader 200 for reading an image from a document, and a printer 300 for forming the read image on a sheet.

The image reader 200 has a document feeder 100 mounted thereon. The document feeder 100 sequentially feeds documents set on an document tray 101 in a face-up manner, one by one leftward as viewed in FIG. 1, starting with a top page. After passing through a curved path, each fed document is conveyed on a platen glass 102 from left to right such that it passes a reading position, and is then discharged toward a discharge tray 112 disposed outside. When each document passes the reading position on the platen glass 102 from left to right, an image of the document is read by a scanner unit 104 held at the reading position. More specifically, when each document passes the reading position, a side of the document from which the image is to be read is irradiated with light from a lamp 103 of the scanner unit 104, and light reflected from the document is guided to a lens 108 via mirrors 105 to 107. The light having passed through the lens 108 forms an image on an imaging surface of an image sensor 109.

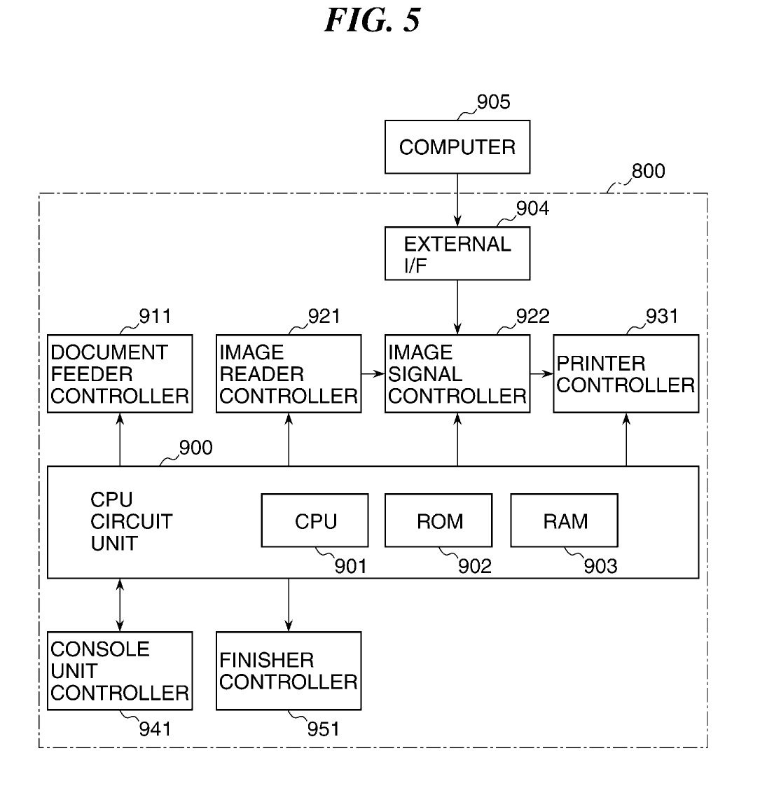

The image of the document, which has been optically read, is converted by the image sensor 109 to image data and then is output. The image data output from the image sensor 109 is subjected to predetermined processing by an image signal controller 922 (see FIG. 5), and then is input to an exposure controller 110 of the printer 300 as a video signal.

The exposure controller 110 modulates a laser beam based on the input video signal, and outputs the modulated laser beam. The output laser beam is irradiated onto a photosensitive drum 111 while being scanned by a polygon mirror 110a. An electrostatic latent image is formed on the photosensitive drum 111 according to the scanned laser beam.

The electrostatic latent image is visualized with developer (toner) supplied from a developing device 113, as a toner image. Further, a sheet is fed from one of an upper cassette 114, a lower cassette 115, a manual sheet feeder 125, and a sheet refeed path 124, toward an image formation path 120, in synchronism with the start of irradiation of the laser beam. The upper cassette 114, the lower cassette 115, and the manual sheet feeder 125 function as an accommodation unit configured to accommodate sheets.

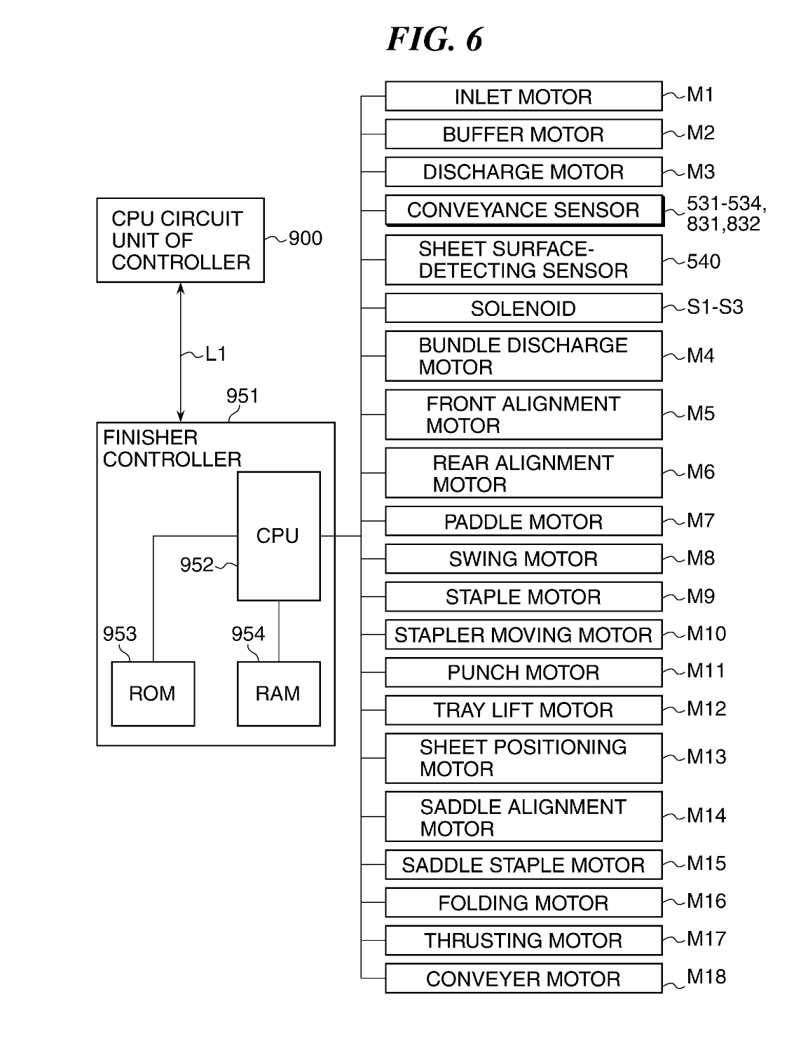

When the fed sheet reaches a roller 119, the sheet is temporarily stopped. A CPU circuit unit 900 (see FIG. 5) of the image forming apparatus 10 refers to job information to check the sheet size and post-processing mode of each of the temporarily stopped sheets and a sheet (immediately preceding sheet) conveyed immediately before the temporarily stopped sheet, and calculates a post-processing time required by the apparatus 10 to thereby determine a sheet conveyance-time interval from the immediately preceding sheet. Thus, in the present embodiment, the CPU circuit unit 900 of the image forming apparatus 10 determines the sheet conveyance-time interval based on the contents of the job information. However, this is not limiting as the CPU circuit unit 900 may notify a controller 951 of the finisher 500 (hereinafter referred to as the “finisher controller”) (see FIG. 6) of job information via a communication line L1 (see FIG. 6), and the finisher controller 951 may determine a sheet conveyance-time interval based on the job information, and output the determined sheet conveyance-time interval to the image forming apparatus 10 via the communication line L1, whereby the image forming apparatus 10 may acquire a sheet conveyance-time interval. Note that the job information includes the size and basis weight of a sheet, the type of sheet material, the post-processing mode and so on.

The sheet which has been temporarily stopped remains in the stopped state until a time corresponding to the determined sheet conveyance-time interval elapses. When the time corresponding to the determined sheet conveyance-time interval has elapsed, the sheet is released from the stopped state, and is conveyed to a nip between the photosensitive drum 111 and a transfer section 116. Then, the transfer section 116 transfers the toner image formed on the photosensitive drum 111 onto the sheet.

The sheet on which the toner image has been transferred is conveyed to a fixing section 117, and the fixing section 117 fixes the toner image on the sheet by heating and pressing the sheet. The sheet having passed the fixing section 117 is discharged from the printer 300 to the outside of the image forming apparatus 10, i.e. to the finisher 500, via a flapper 121 and discharge rollers 118.

In this operation, to discharge the sheet in a state in which an image-formed side thereof faces downward (face-down state), the sheet having passed the fixing section 117 is once introduced into an inversion path 122 by a switching operation of the flapper 121. Then, after a trailing edge of the sheet passes the flapper 121, the sheet is switched back, and is discharged from the printer 300 by the discharge rollers 118. This manner of sheet discharge is referred to as the “inverted discharge”. The inverted discharge is performed, when images are sequentially formed starting with a top page, as in a case where images read from documents are formed on sheets using the document feeder 100 or in a case where images output from a computer 905 (see FIG. 5) are formed on sheets, and the sheets are discharged such that the discharged sheets are in a correct page order.

Further, in a case where a double-sided printing job for forming images on both sides of a sheet is instructed, the sheet is guided into the inversion path 122 by the switching operation of the flapper 121, further conveyed to a double-sided printing inversion path 123, and then temporarily stopped. Thereafter, the sheet is switched back to be conveyed to the sheet refeed path 124, and is fed again to between the photosensitive drum 111 and the transfer section 116 at the above-mentioned timing. In this case, the sheet is discharged by the discharge rollers 118 in a state in which an image-formed side of the sheet faces upward (face-up state) without guiding the sheet to the inversion path 122.

The sheet discharged from the printer 300 is conveyed into the finisher 500. The finisher 500 performs the above-mentioned various kinds of post processing on the sheet.

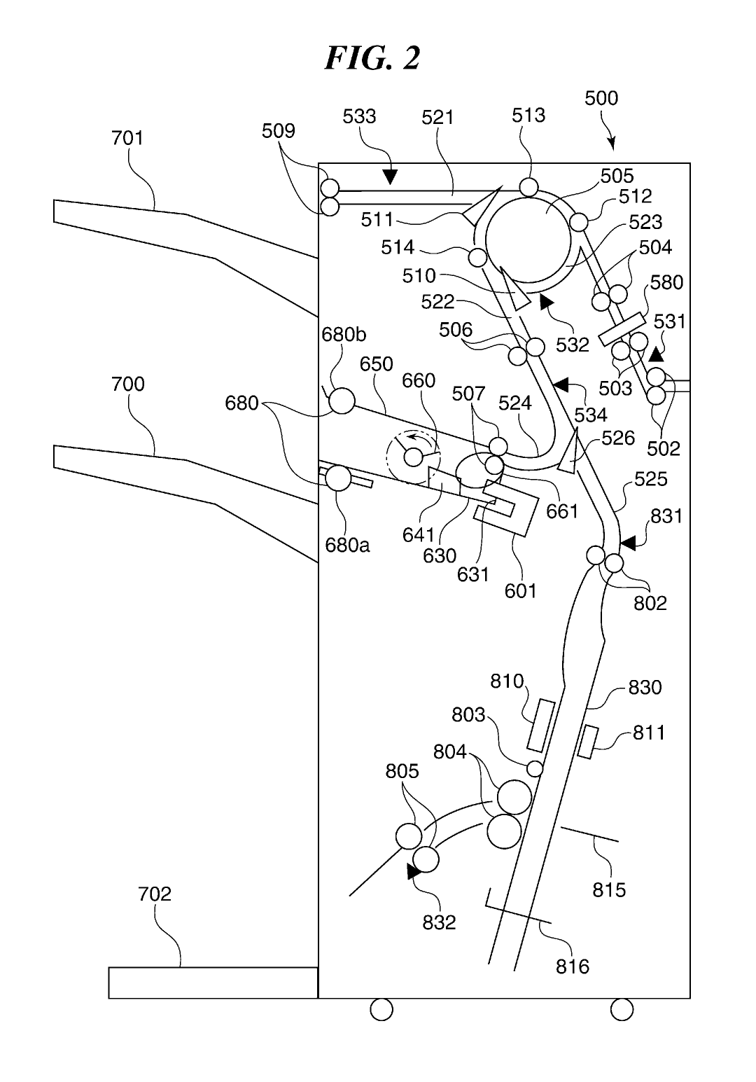

FIG. 2 is a detailed cross-sectional view of the finisher 500.

In FIG. 2, the sheet discharged from the image forming apparatus 10 is transferred to an inlet roller pair 502 of the finisher 500. The inlet roller pair 502 is driven by an inlet motor M1 (see FIG. 6), to guide the sheet discharged from the image forming apparatus 10 into the finisher 500. The sheet guided into the finisher 500 by the inlet roller pair 502 is conveyed toward a buffer roller 505 by conveyance roller pairs 503 and 504 which are similarly driven by the inlet motor M1. A conveyance sensor 531 is disposed at a predetermined location on a conveying passage between the inlet roller pair 502 and the conveyance roller pair 503, and detects a passage of the sheet at the location.

A punch unit 580 is disposed at a predetermined location between the conveyance roller pairs 503 and 504. To punch a trailing end of a sheet, the finisher 500 stops the conveyance of the sheet at timing where the trailing end of the sheet reaches the punch unit 580, and drives the punch unit 580 by a punch motor M11 (see FIG. 6) to punch the sheet.

The buffer roller 505 is driven by a buffer motor M2 (see FIG. 6). The buffer roller 505 has a predetermined number of sheets, which have been conveyed thereto by the conveyance roller pairs 503 and 504, wrapped around an outer periphery thereof, in a stacked manner. The conveyed sheets are wrapped around the outer periphery of the buffer roller 505 by rotation thereof while being held down by holding rollers 512 to 514. The wrapped sheets are conveyed in a rotational direction of the buffer roller 505. In the present embodiment, the size of a sheet which can be wrapped around the buffer roller 505 is not larger than 216 mm in length in the sheet conveying direction. Therefore, an A3-size sheet (420 mm×297 mm) cannot be wrapped around the buffer roller 505.

A switching flapper 511 which is driven by a solenoid S1 (see FIG. 6) is disposed between the holding rollers 513 and 514, and a switching flapper 510 which is driven by a solenoid S2 (see FIG. 6) is disposed at a location downstream of the holding roller 514.

The switching flapper 511 is used for removing sheets wrapped around the buffer roller 505 from the buffer roller 505, and guiding the removed sheets to a non-sort path 521.

The switching flapper 510 is used for removing sheets wrapped around the buffer roller 505 from the buffer roller 505, and guiding the removed sheets to a sort path 522, or for guiding the sheets to a buffer path 523 in a state wrapped around the buffer roller 505.

To guide the sheets wrapped around the buffer roller 505 into the non-sort path 521, the switching flapper 511 is operated to remove the sheets wrapped around the buffer roller 505 from the buffer roller 505, and guides the removed sheets into the non-sort path 521. The sheets guided into the non-sort path 521 are discharged onto a sample tray 701 by a conveyance roller pair 509 which is driven by a discharge motor M3 (see FIG. 6). A conveyance sensor 533 for detecting a state of conveyance of a sheet on the non-sort path 521 is disposed at a predetermined location on the non-sort path 521.

To guide a sheet or sheets wrapped around the buffer roller 505 into the buffer path 523, neither the switching flapper 510 nor 511 is operated, but the sheet(s) is (are) conveyed to the buffer path 523 in the state wrapped around the buffer roller 505. A conveyance sensor 532 for detecting a state of conveyance of a sheet or sheets on the buffer path 523 is disposed at a predetermined location on the buffer path 523.

When the sheets wrapped around the buffer roller 505 are guided into the sort path 522, the switching flapper 511 is not operated but the switching flapper 510 is operated to thereby remove the sheets wrapped around the buffer roller 505 from the buffer roller 505 and guide the removed sheets to the sort path 522. The sheets guided into the sort path 522 are guided into a lower discharge path 524 or a bookbinding path 525 via a conveyance roller pair 506 which is driven by the discharge motor M3 (see FIG. 6) and a switching flapper 526 which is driven by a solenoid S3 (see FIG. 6). A conveyance sensor 534 for detecting a state of conveyance of a sheet on the sort path 522 is disposed at a predetermined location on the sort path 522.

The sheets guided into the lower discharge path 524 by the switching flapper 526 are discharged onto a processing tray 630 by a conveyance roller pair 507. The sheets discharged onto the processing tray 630 are drawn back toward the trailing edge side in the sheet conveying direction by a knurled belt 661 which is driven in synchronism with the conveyance roller pair 507 and a paddle 660 which is driven by a paddle motor M7 (see FIG. 6). The sheets having been drawn back are brought into abutment with a stopper 631 and stopped there.

Alignment members 641 disposed on the processing tray 630 at respective locations on the near side and far side in a lateral direction orthogonal to the sheet conveying direction are moved by a front alignment motor M5 and a rear alignment motor M6 (see FIG. 6) in the width direction, respectively. Note that the “near side” refers to a side toward the viewer of FIG. 2, and the “far side” refers to a side remote from the viewer of FIG. 2 (the same shall apply hereinafter).

The sheets stacked on the processing tray 630 are subjected to alignment processing by the alignment members 641, and stapling or the like, as required, and then are discharged onto a stacking tray 700 by a discharge roller pair 680 formed by discharge rollers 680a and 680b.

The discharge roller pair 680 is driven by a bundle discharge motor M4 (see FIG. 6). The discharge roller 680b is supported by a swing guide 650. The swing guide 650 is driven by a swing motor M8 (see FIG. 6) to swing in a manner bringing the discharge roller 680b into contact with an uppermost one of the sheets on the processing tray 630. When the discharge roller 680b is in contact with the uppermost sheet on the processing tray 630, the discharge roller 680b cooperates with the discharge roller 680a to discharge the sheet bundle on the processing tray 630 toward the stacking tray 700.

The stacking tray 700 is lifted up and down by a tray lift motor M12 (see FIG. 6). A surface of the stacking tray 700 or an upper surface of the uppermost one of the sheets on the stacking tray 700 is detected by a sheet surface-detecting sensor 540 (see FIG. 6). The tray lift motor M12 is drivingly controlled such that the surface of the stacking tray 700 or the upper surface of the uppermost sheet is at a fixed level based on the sensor output from the paper surface-detecting sensor 540. Note that the sample tray 701 is not lifted up and down as the stacking tray 700, and is fixed at a location shown in FIG. 2.

Stapling is performed by a stapler 601. The stapler 601 is driven by a staple motor M9 (see FIG. 6), and performs processing for securing a trailing end of a sheet bundle stacked on the processing tray 630 in the sheet conveying direction with staples, i.e. stapling. Further, the stapler 601 is configured to be movable along an outer periphery of the processing tray 630 by a stapler moving motor M10 (see FIG. 6), and is moved to a designated stapling position before the sheets reach the stapling position.

The sheets guided from the sort path 522 into the bookbinding path 525 by the switching flapper 526 are guided into a bookbinding tray 830 by a roller pair 802 which is driven by the discharge motor M3. A bookbinding inlet sensor 831 is disposed at a predetermined location on the bookbinding path 525.

The bookbinding tray 830 is provided with an intermediate roller 803 driven by the discharge motor M3, and a sheet positioning member 816 which is driven by a sheet positioning motor M13 (see FIG. 6) to move up or down along the bookbinding tray 830. The sheet positioning member 816 waits at a location distant from a position where a saddle stapler 810 performs stapling, by half the length of a sheet, and receives each sheet entering the bookbinding tray 830.

Saddle alignment members (not shown) provided on the near side and far side of the bookbinding tray 830 are moved by a saddle alignment motor M14 (see FIG. 6) in a direction orthogonal to the sheet conveying direction, and performs aligning of the sheets stacked on the bookbinding tray 830.

Further, an anvil 811 is provided at a location opposed to the saddle stapler 810. The saddle stapler 810 is driven by a saddle staple motor M15 (see FIG. 6), and cooperates with the anvil 811 to perform stapling of the sheet bundle stacked on the bookbinding tray 830.

At respective locations downstream of the stapler 810, there are provided a folding roller pair 804 which is driven by a folding motor M16 (see FIG. 6) and a thrusting member 815 at a location opposed to the folding roller pair 804. The thrusting member 815 is actuated by a thrusting motor M17 (see FIG. 6) whereby it is thrust toward the sheet bundle received in the bookbinding tray 830 and thrusts the sheet bundle in between the folding roller pair 804, in a folded state.

The folding roller pair 804 conveys the sheet bundle pushed therein in the folded state downstream. The folded sheet bundle is further conveyed by a folding roller pair 805 which is driven by the folding motor M16, and is then discharged onto a book tray 702. A bookbinding outlet sensor 832 is disposed immediately downstream of the folding roller pair 805, for detecting a state of conveyance of the folded sheet bundle.

The sheet bundles discharged onto the book tray 702 are sequentially conveyed downstream by a conveyer motor M18 (see FIG. 6).

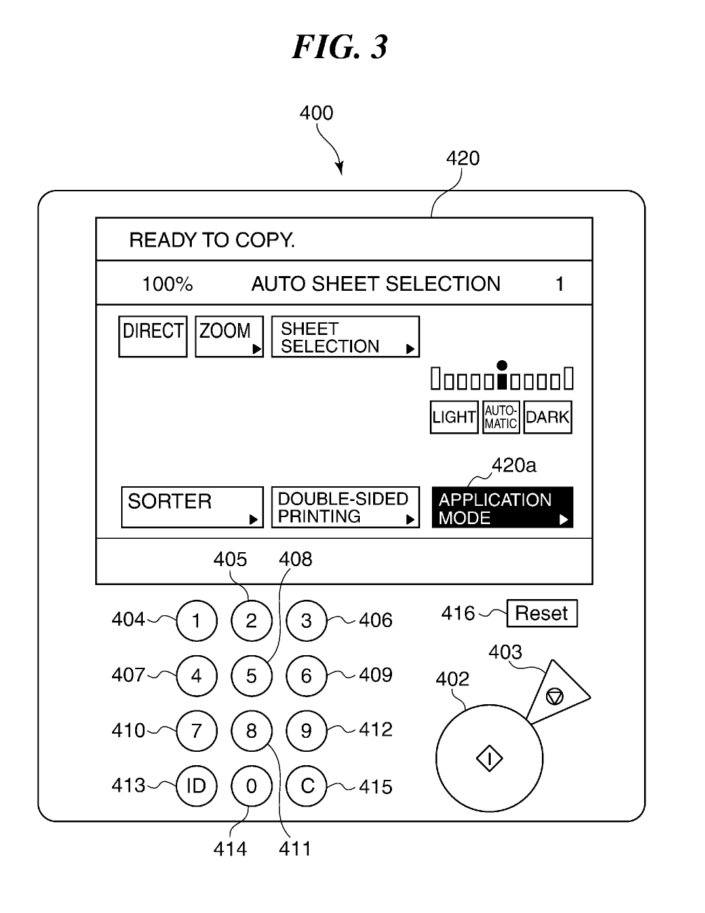

FIG. 3 is a plan view of the appearance of a console unit 400 appearing in FIG. 1.

As shown in FIG. 3, arranged on the console unit 400 are a start key 402 for starting an image formation operation (print job), a stop key 403 for interrupting the image formation operation, numeric keys 404 to 412 and 414 for setting e.g. numerical values, an identification (ID) key 413, a clear (C) key 415, and a reset key (Reset) key 416. Further, a liquid crystal display section 420 comprising a touch panel is provided on an upper part of the console unit 400, and displays various software keys on a screen thereof.

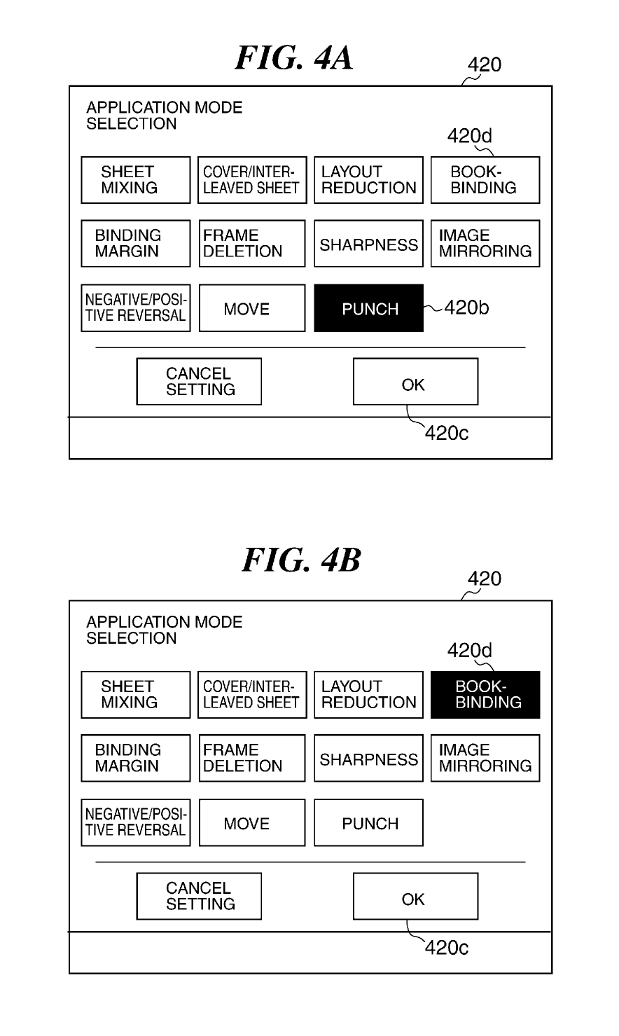

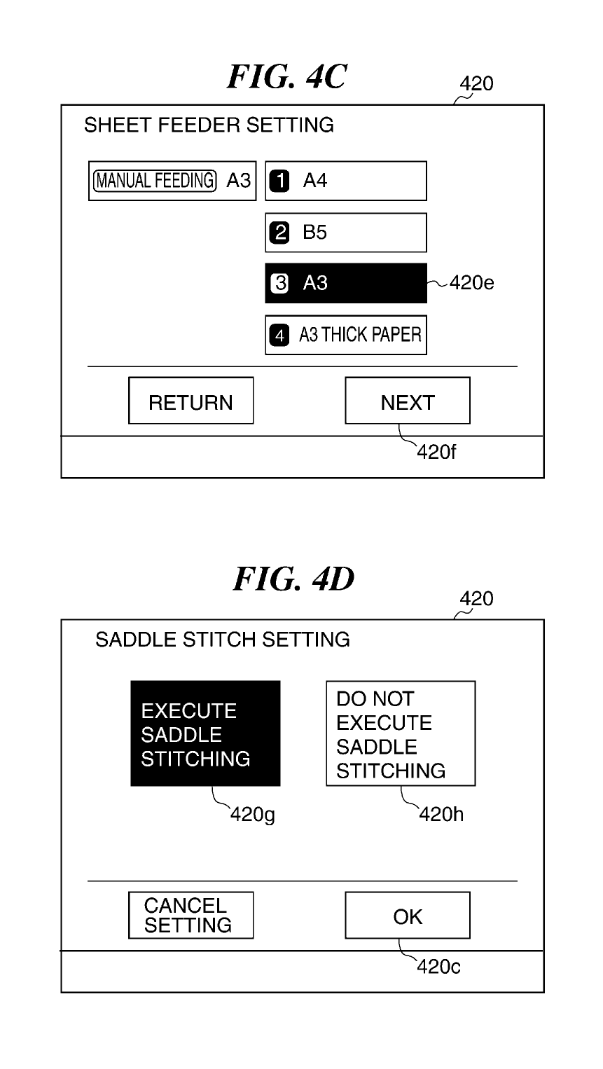

The image forming system 1000 has various post-processing modes, including a non-sort mode, a sort mode, a staple sort mode (binding mode), and a bookbinding mode. The selective setting of the post-processing mode is performed according to an input operation by a user from the console unit 400. For example, when the user depresses an “application mode” key 420a which is one of the software keys on an initial screen shown in FIG. 3, the “application mode” key 420a is highlighted, and then an “application mode selection” screen is displayed on the liquid crystal display section 420 as shown in FIG. 4A. The user can selectively set a desired mode by operating one of a plurality of mode buttons displayed on the “application mode selection” screen.

When the user depresses e.g. a “punch” key 420b on this screen, the “punch” key 420b is highlighted as shown in FIG. 4A and the punch mode is set. Then, when the user depresses an “OK” key 420c, the setting of the application mode is completed, and then the initial screen shown in FIG. 3 is displayed again. Then, when the user depresses the start key 402, punching is started.

On the other hand, when the user depresses a “bookbinding” key 420d, the “bookbinding” key 420d is highlighted as shown in FIG. 4B and a “sheet feeder selection” screen is displayed. As shown in FIG. 4C, keys for selecting one of cassettes containing sheets of various sizes are displayed on the “sheet feeder selection” screen. When the user depresses e.g. a key 420e for selecting a cassette containing A3-size sheets, and then depresses a “next” key 420f, a “saddle stitch-setting” screen is displayed as shown in FIG. 4D.

When the bookbinding mode is selected, at least center folding is performed, and whether or not to perform saddle stitching can be selected by the user. Therefore, when the bookbinding mode is selected, the “saddle stitch-setting” screen is displayed. A “saddle stitch” key 420g and a “non-saddle stitch” key 420h are displayed on the “saddle stitch-setting” screen, and the user selects whether or not to perform saddle stitching using these keys. For example, when the user depresses the “saddle stitch” key 420g, and then depresses the “OK” key 420c, the setting of saddle stitching is completed, and the initial screen shown in FIG. 3 is displayed again. When the setting of the bookbinding mode has been made, and the user depresses the start key 402, bookbinding is started. Note that when the saddle stitching mode is set, a double-sided printing mode is automatically set.

In the present embodiment, the finisher 500 is permitted to perform saddle stitching of sheets on condition that the length of the sheets in the sheet conveying direction is not smaller than 279.4 mm. On the other hand, sheets which can be wrapped around the buffer roller 505 have a length of not larger than 216 mm in the sheet conveying direction, as mentioned above. Therefore, when saddle stitching is performed by the finisher 500, buffering cannot be performed.

FIG. 5 is a block diagram of a controller 800 that controls the overall operation of the image forming system 1000.

As shown in FIG. 5, the controller 800 includes the CPU circuit unit 900, which incorporates a CPU (central processing unit) 901, a ROM (read only memory) 902, and a RAM (random access memory) 903. The CPU 901 executes a control program stored e.g. in the ROM 902 to thereby control the overall operation of the image forming system 1000, specifically, controllers 911, 921, 922, 931, 941, and 951. The RAM 903 temporarily stores control data, and is also used as a work area for computing operations executed according to the control.

The document feeder controller 911 drivingly controls the document feeder 100 based on instructions from the CPU circuit unit 900. The image reader controller 921 drivingly controls the scanner unit 104, the image sensor 109, and so forth, and transfers an analog image signal output from the image sensor 109 to the image signal controller 922.

The image signal controller 922 converts an analog image signal output from the image sensor 109 to a digital image signal, and then perform various kinds of signal processing on the digital signal, whereafter the image signal controller 922 converts the processed digital signal to a video signal, and then outputs the video signal to the printer controller 931. Further, the image signal controller 922 performs various kinds of signal processing on a digital image signal input from the computer 905 via an external interface (I/F) 904, converts the digital image signal to a video signal, and then outputs the video signal to the printer controller 931. The processing operation performed by the image signal controller 922 is controlled by the CPU circuit unit 900. The printer controller 931 drives the exposure controller 110 based on the input video signal.

The console unit controller 941 operates to cause information to be exchanged between the console unit 400 and the CPU circuit unit 900. The console unit 400 outputs a key signal corresponding to the operation of each of the keys 402 to 416 (see FIG. 3) to the CPU circuit unit 900 (including the operation of each software key), and receives a signal from the CPU circuit unit 900 to display information corresponding to the signal on the liquid crystal display section 420.

The finisher controller 951 is mounted on the finisher 500, and exchanges information with the CPU circuit unit 900 to thereby drivingly control the overall operation of the finisher 500.

FIG. 6 is a block diagram of the finisher controller 951.

As shown in FIG. 6, the finisher controller 951 includes a CPU 952, a ROM 953, and a RAM 954. The finisher controller 951 communicates with the CPU circuit unit 900 of the image forming apparatus 10 via a communication IC (integrated circuit) (not shown) and the communication line L1 to thereby exchange data, such as job information and notification of reception/delivery of a sheet, therewith. Further, the finisher controller 951 executes various programs stored in the ROM 953 according to instructions from the CPU circuit unit 900 to thereby drivingly control the finisher 500.

The finisher 500 includes the inlet motor M1, the buffer motor M2, the discharge motor M3, the solenoids S1 to S3, and the conveyance sensors 531 to 534 for conveying sheets as described above. Further, the finisher 500 is provided with the bundle discharge motor M4, the front alignment motor M5, the rear alignment motor M6, the paddle motor M7, the swing motor M8, the staple motor M9, the stapler moving motor M10, the punch motor M11, and the tray lift motor M12 for performing post processing, such as sorting, punching, and stapling, as described hereinabove. Further, the finisher 500 includes the bookbinding inlet sensor 831 and bookbinding outlet sensor 832, the sheet positioning motor M13, the saddle alignment motor M14, the saddle staple motor M15, the folding motor M16, the thrusting motor M17, and the conveyer motor M18, for performing the bookbinding process as described above. The motors M1 to M18 and the solenoids S1 to S3 are controlled by the finisher controller 951 based on the sensor outputs from the various sensors 531 to 534, and 831 and 832, and hence the motors M1 to M18, the solenoids S1 to S3, and the various sensors 531 to 534, and 831 and 832 are connected to the finisher controller 951.

The image forming system 1000 is capable of executing two types of double-sided image formation processes (double-sided printing circulation methods) using “alternate circulation” (second double-sided image formation process) and “block circulation” (first double-sided image formation process), respectively, and switches the double-sided image formation process between these two types according to predetermined conditions. Hereafter, the double-sided image formation processes using “alternate circulation” and “block circulation” will be described, respectively, assuming that a print job including the following settings is provided:

sheet feeder: lower cassette 115 (sheet size: A3);

number of sheets to be printed: three sheets×three sets;

post-processing mode: non-sort mode

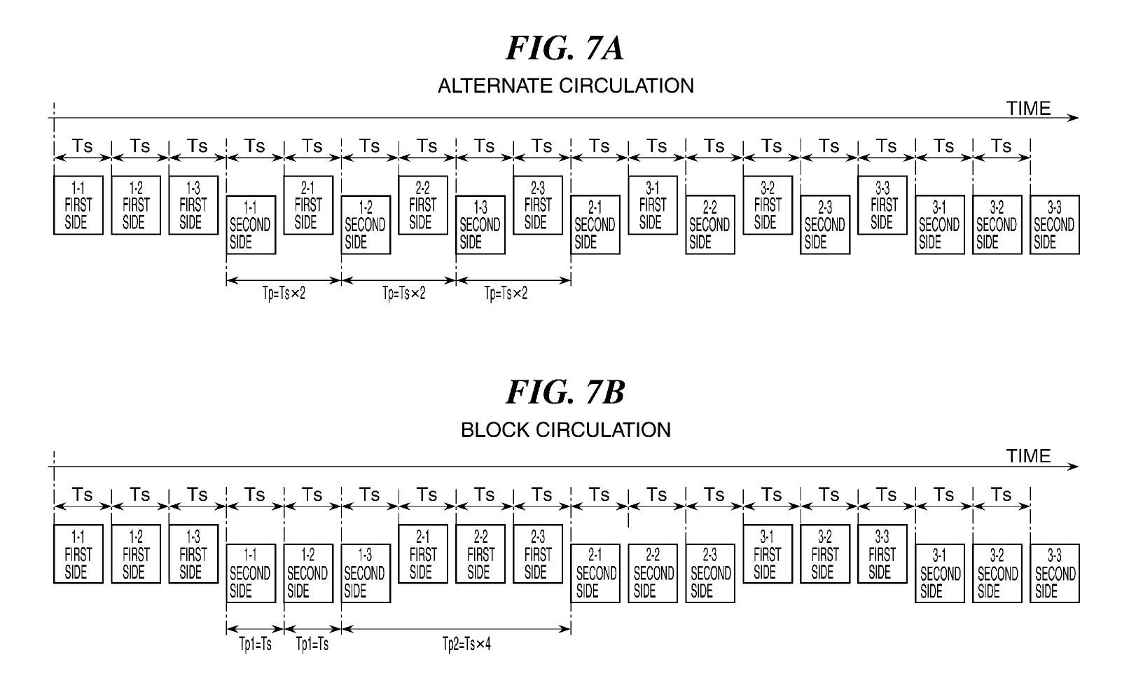

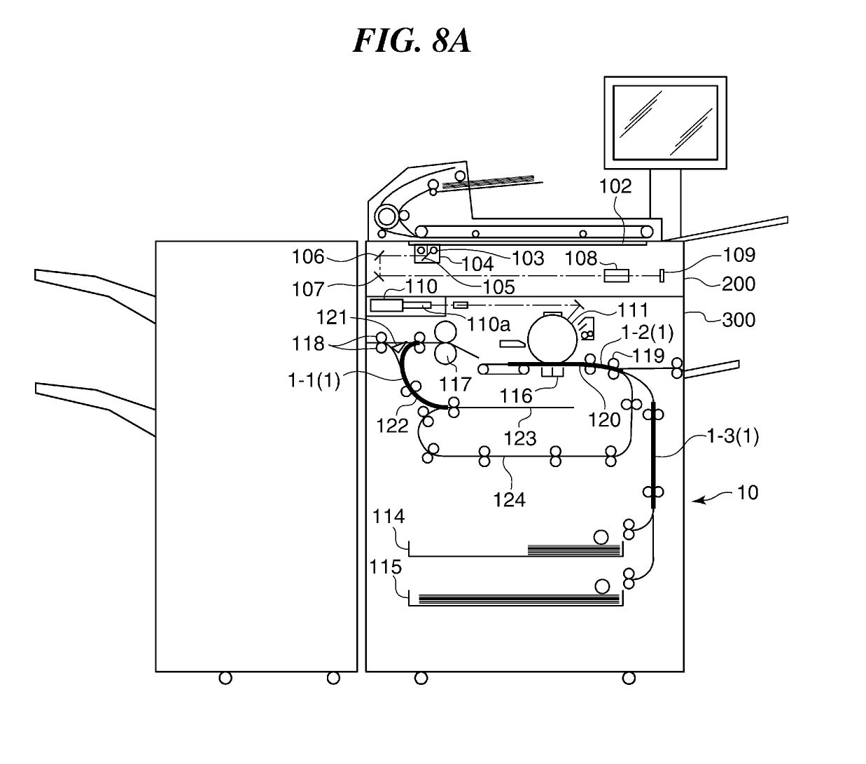

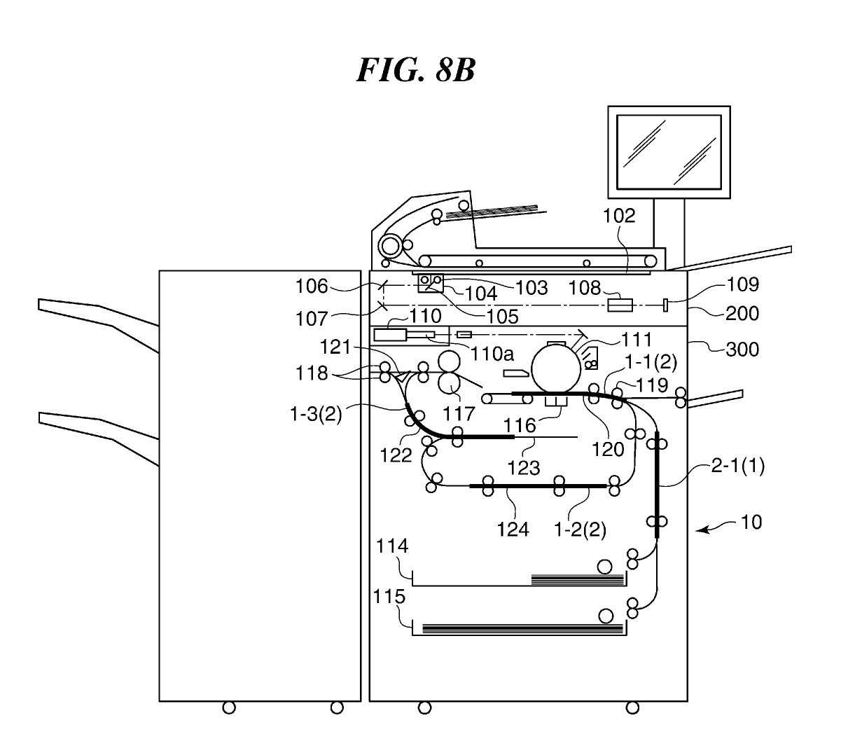

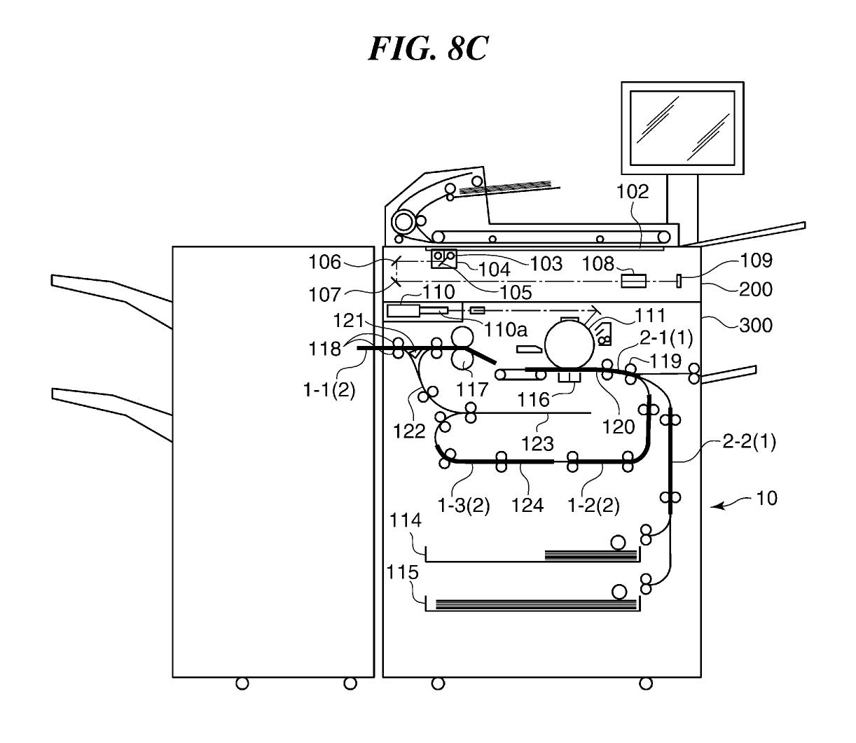

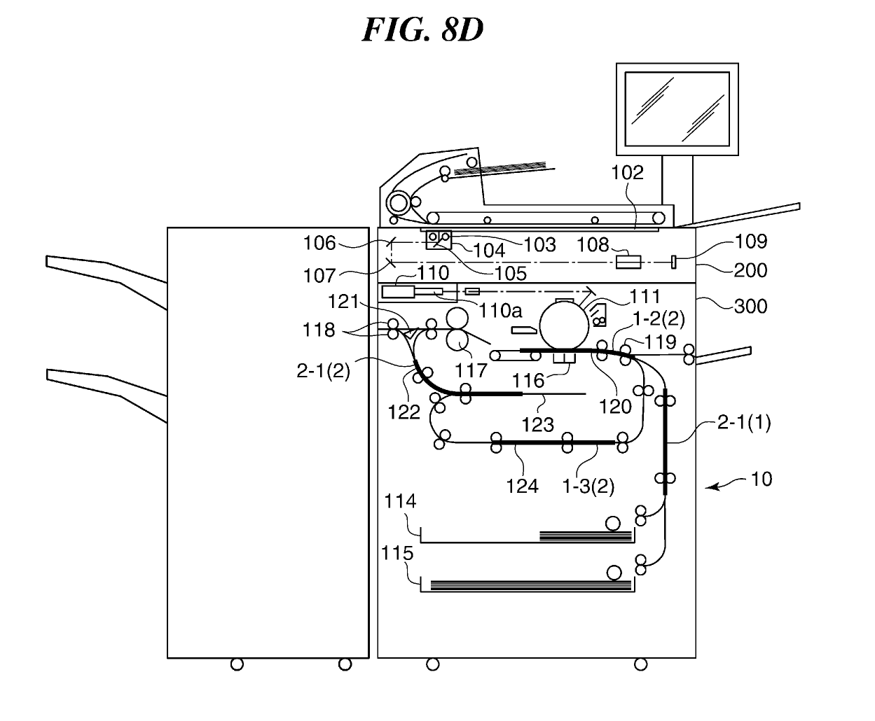

First, the double-sided image formation process using “alternate circulation” will be described with reference to FIGS. 7A and 8A to 8D.

FIGS. 7A and 7B are diagrams each showing an example of a schedule for transferring toner images onto sheets by the transfer section 116 when the above-mentioned print job is instructed, and the horizontal axis in each of FIGS. 7A and 7B indicates time. FIG. 7A shows the schedule set when “alternate circulation” is selected, and FIG. 7B shows the schedule set when “block circulation” is selected.

A sheet “m-n” (m and n each represent one of integers of 1 to 3) in each of blocks in FIGS. 7A and 7B indicates an n-th sheet of an m-th sheet bundle out of three sheet bundles each formed of three sheets. Further, “first side” indicates a first side of each sheet, and “second side” indicates a second side of the sheet.

FIGS. 8A to 8D are diagrams each showing a state of conveyance of sheets along the conveying paths in the image forming apparatus 10 in a case where “alternate circulation” is selected. A sheet m-n (k) (m and n each represent one of integers of 1 to 3; k represent an integer 1 or 2) shown in FIGS. 8A to 8D indicates that an image formation target is a k-th (in the illustrated example, first or second) side of an n-th (in the illustrated example, first, second or third) sheet of an m-th (in the illustrated example, first, second or third) sheet bundle. Note that in the present embodiment, the “image formation target” includes not only a sheet side (surface) on which an image is to be formed, but also a sheet side (surface) on which an image has been formed.

When “alternate circulation” is started, first, as shown in FIG. 8A, a second predetermined number of sheets, i.e. only three sheets are sequentially fed from the lower cassette 115, and an image is formed on a first side of each sheet.

Then, when the first sheet on which an image has been formed on the first side thereof comes to the sheet refeed path 124, thereafter, as shown in FIG. 8B, sheet re-conveyance from the sheet refeed path 124 and sheet feed from the lower cassette 115 are controlled such that the sheet to be conveyed to the image formation path 120 is alternately switched between a sheet of which the image formation target is a first side and a sheet of which the image formation target is a second side.

Thereafter, as shown in FIG. 8C, a sheet on which images have been formed on both of the first and second sides thereof is conveyed toward the finisher 500, and a sheet on which an image has been formed only on the first side thereof is conveyed from the inversion path 122 to the double-sided printing inversion path 123.

Then, as shown in FIG. 8D, a sequence of the above-described operations is repeated until the number of sheets designated by the print job, i.e. 9 sheets=3 sheets×3 sets (a plurality of sheets) are fed from the lower cassette 115.

In “alternate circulation”, as shown in FIG. 7A, after the respective first sides of three sheets (second predetermined number of sheets) of the first set are continuously subjected to image formation, “1-1 (second side)” which is a second side of the first sheet of the first set is subjected to image formation. After that, image formation on a first side and image formation on a second side are alternately performed. Then, when “3-3 (first side)” which is a first side of a third sheet of a third set is subjected to image formation, the respective second sides of three sheets (second predetermined number of sheets) of the third set are continuously subjected to image formation. At this time, assuming that a time interval at which image formation on a sheet is performed by the transfer section 116 (hereinafter referred to as the “image formation time interval”) is represented by “Ts”, a time interval Tp at which sheet discharge to the finisher 500 disposed downstream of the image forming apparatus 10 is performed (hereinafter referred to as the “sheet discharge time interval”) can be calculated by the following equation:

Tp=Ts×2

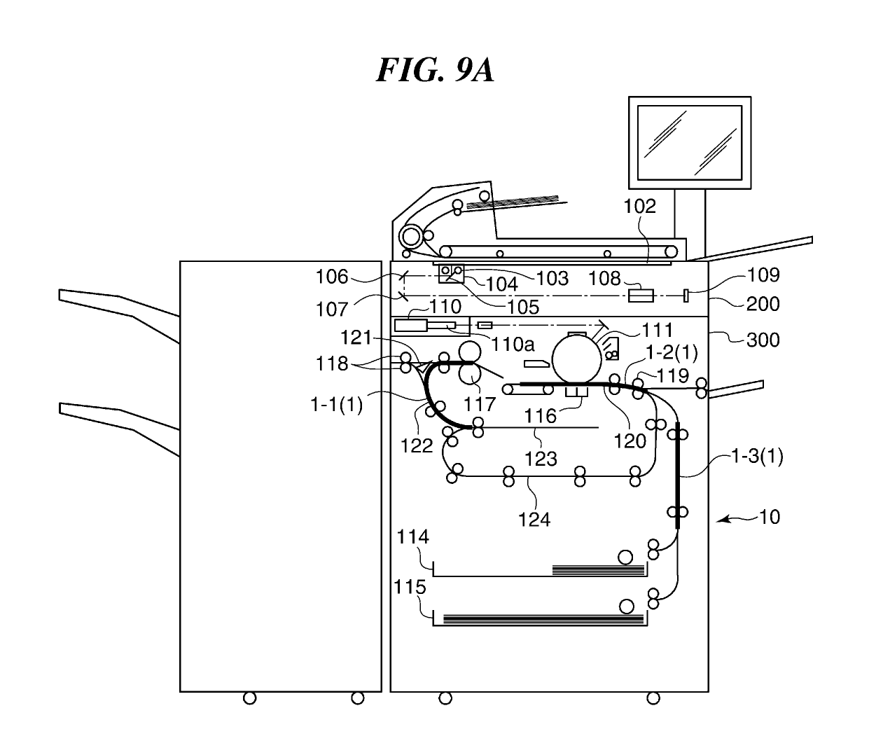

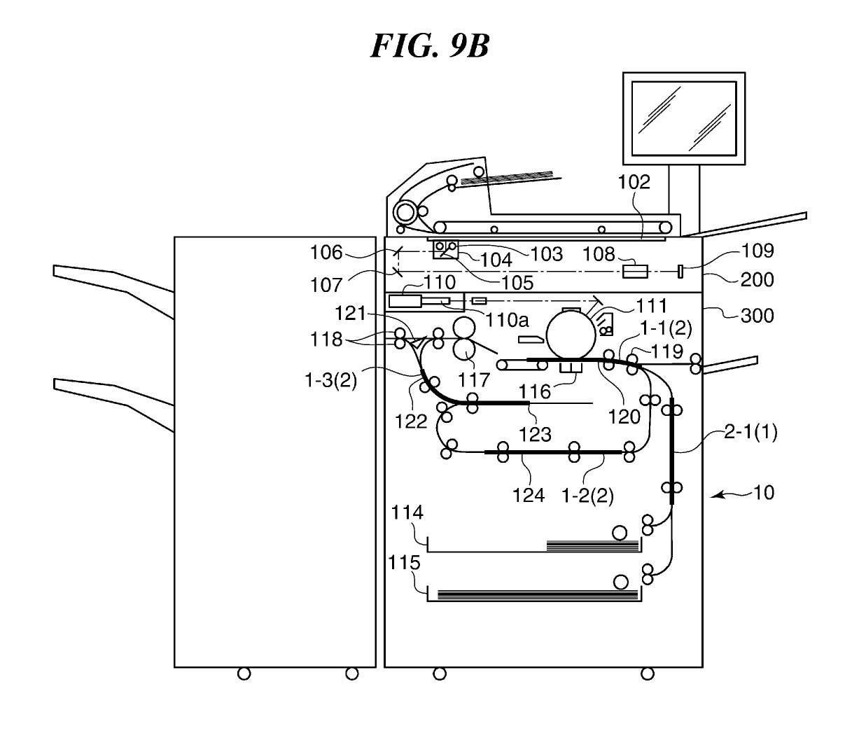

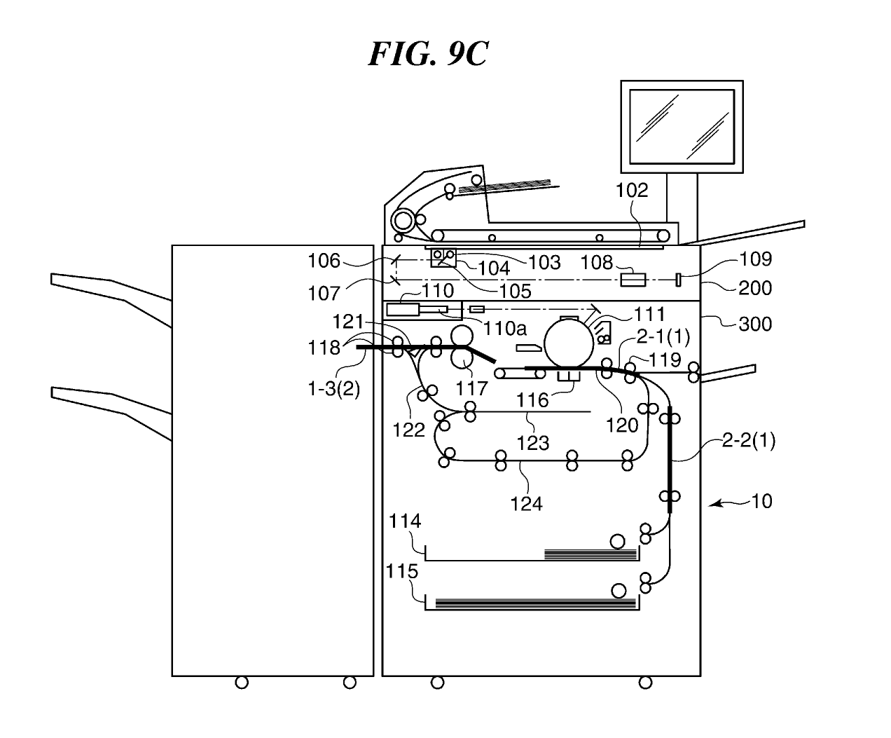

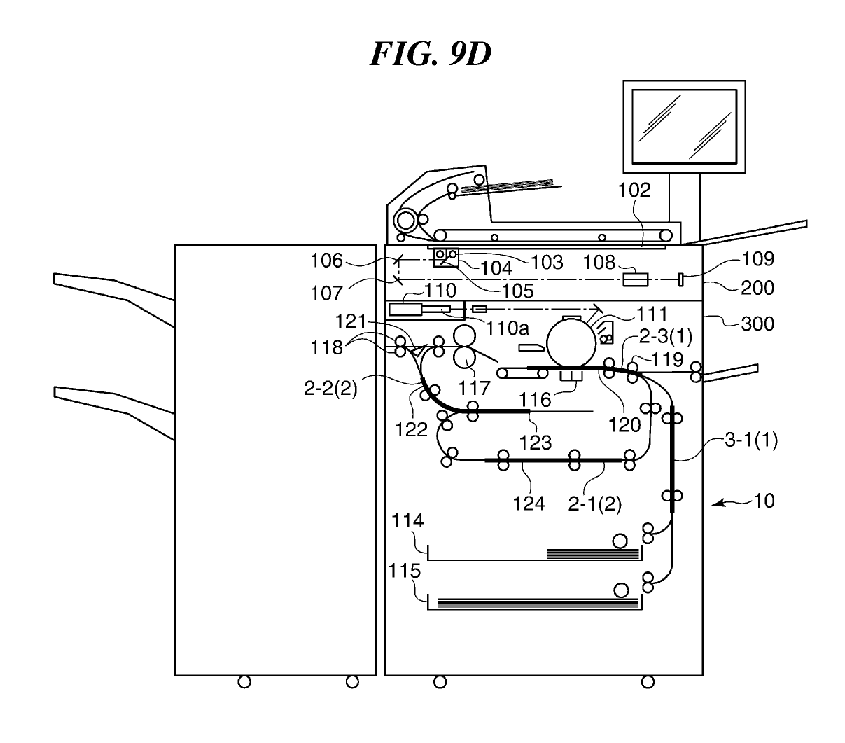

Next, the double-sided image formation process using “block circulation” will be described with reference to FIGS. 7B and 9A to 9D.

FIGS. 9A to 9D are diagrams each showing a state of conveyance of sheets along the sheet conveying paths in the image forming apparatus 10 in a case where “block circulation” is selected.

When “block circulation” is started, first, as shown in FIG. 9A, a plurality of sheets, e.g. three sheets (first predetermined number of sheets) are sequentially fed from the lower cassette 115, and an image is formed on a first side of each sheet.

Then, when the first sheet of a sheet group (block) on which images have been formed on the first sides, respectively, reaches the sheet refeed path 124 after passing the fixing section 117, the inversion path 122, and the double-sided printing inversion path 123, continuous feeding of sheets from the lower cassette 115 is stopped.

Thereafter, as shown in FIG. 9B, the first sheet on which an image has been formed on the first side thereof is conveyed from the sheet refeed path 124 to the image formation path 120 again, and an image is formed on the second side of the first sheet, whereafter the first sheet is conveyed to the finisher 500.

As described above, in the double-sided printing with respect to a sheet group formed by the first predetermined number of sheets, when the last one of the first predetermined number of sheets is conveyed from the sheet refeed path 124 to the image formation path 120, as shown in FIG. 9C, a first sheet of the next sheet group formed by the first predetermined number of sheets is fed from the lower cassette 115 to start double-sided printing for the next sheet group formed by the first predetermined number of sheets.

Thereafter, as shown in FIG. 9D, the double-sided printing operation is repeated on each group formed of the first predetermined number of sheets.

In “block circulation”, as shown in FIG. 7B, when images have been sequentially formed on the respective first sides of the first predetermined number of sheets, after “1-3 (first side)” which is the first side of the last sheet of the first predetermined number of sheets, “1-1 (second side)” which is the second side of the first sheet is subjected to image formation, and after “1-3 (second side)” which is the second side of the last sheet of the first predetermined number of sheets, “2-1 (first side)” which is the first side of the first sheet of the next first predetermined number of sheets is subjected to image formation.

Then, the sheet feed timing is controlled such that a sheet feed time interval between the last one of the first predetermined number of sheets and the first one of the next first predetermined number of sheets is larger than a sheet feed time interval before that.

At this time, assuming that a time interval at which image formation on a sheet is performed by the transfer section 116, i.e. “the image formation time interval” is represented by “Ts”, a sheet discharge time interval Tp1 not corresponding to a break in the circulation and a sheet discharge time interval Tp2 corresponding to a break in the circulation can be calculated by the following equations:

Tp1=Ts

Tp2=Ts×(N+1)

The sheet discharge time interval Tp1 not corresponding to a break in the circulation is a time interval at which each of the first predetermined number of sheets is discharged during image formation sequentially performed on respective second sides of the first predetermined number of sheets except the last one of these sheets. Further, the sheet discharge time interval Tp2 corresponding to a break in the circulation is a time interval from discharge of the last sheet of the first predetermined number of sheets to discharge the first sheet of the next first predetermined number of sheets. However, “N” represents the number of circulated sheets. Note that the number of circulated sheets which can be circulated is not smaller than the number of sheets forming one group holds, N (the number of circulated sheets) is set to the number of sheets forming one group.

That is, when “block circulation” is performed by using three sheets as one group, the discharge time interval between the third sheet “1-3” of the first group and the first sheet “2-1” of the second group is Tp2=4Ts, which is twice as long as the sheet discharge time interval Tp provided when “alternate circulation” is selected.

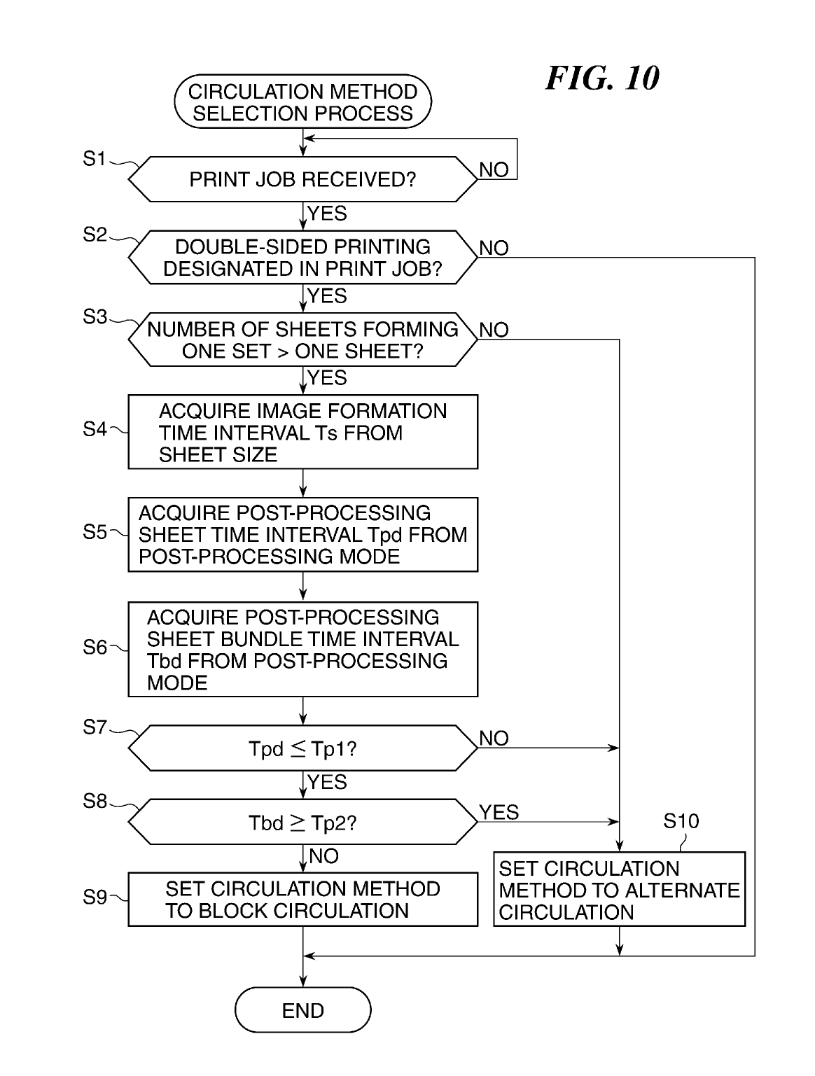

FIG. 10 is a flowchart of a circulation method selection process executed by the image forming apparatus 10, specifically, the CPU 901 of the CPU circuit unit 900.

Referring to FIG. 10, first, the CPU 901 waits until an image formation job (print job) is received (step S1), and when the CPU 901 receives a print job, the CPU 901 determines whether or not double-sided printing is designated in the print job (step S2). If it is determined in the step S2 that single-sided printing is designated, the CPU 901 terminates the present circulation method selection process, whereas if double-sided printing is designated, the CPU 901 proceeds to a step S3.

In the step S3, the CPU 901 determines whether or not a plurality of sheets are designated in the print job as the number of sheets forming each sheet bundle to be printed. If it is determined in the step S3 that one sheet is designated as the number of sheets forming each sheet bundle, the CPU 901 sets the circulation method to “alternate circulation” (step S10), followed by terminating the present circulation method selection process.

On the other hand, if it is determined in the step S3 that a plurality of sheets are designated as the number of sheets forming each sheet bundle, the CPU 901 proceeds to a step S4.

In the step S4, the CPU 901 calculates the image formation time interval Ts for each sheet based on the size of sheets to be printed. For example, when images are formed at a print speed of 30 PPM (page per minute) on A3-size sheets, the image formation time interval Ts=2000 (msec) is calculated. The calculated image formation time interval Ts is stored in the RAM 903. The method of setting the image formation time interval Ts is not limited to this calculation, but the image formation time interval Ts may be set by preparing a table associating sheet sizes and values of the image formation time interval and storing the table in the ROM 902 in advance, reading out a value of the image formation time interval associated with a sheet to be printed from this table, and setting the value thus read out from the table as the image formation time interval Ts.

Next, in a step S5, the CPU 901 calculates a post-processing sheet time interval Tpd, as a first post-processing time interval, based on the post-processing mode designated in the print job received in the step S1. The post-processing sheet time interval Tpd is a post-processing time interval between the sheets. The post-processing sheet time interval Tpd is stored in the RAM 903. The method of setting the post-processing sheet time interval Tpd is not limited to this calculation, but the post-processing sheet time interval Tpd may be set by preparing a table associating post-processing modes and values of the post-processing sheet time interval and storing the table in the ROM 902 in advance, reading out a value of the post-processing sheet time interval associated with a post-processing mode designated in the print job from this table, and setting the value thus read out from the table as the post-processing sheet time interval Tpd. Alternatively, a value of the post-processing sheet time interval acquired from the finisher controller 951 via the communication line L1 (see FIG. 6) may be set as the post-processing sheet time interval Tpd.

Then, in a step S6, the CPU 901 calculates a post-processing sheet bundle time interval Tbd as a second post-processing time interval based on the post-processing mode designated in the print job received in the step S1. The calculated post-processing sheet bundle time interval Tbd is stored in the RAM 903. The post-processing sheet bundle time interval Tbd is a post-processing time interval between the sheet bundles. The post-processing sheet bundle time interval Tbd may be similarly read out from a table stored in the ROM 902 in advance and be set, or may be acquired from the finisher controller 951 via the communication line L1 and be set.

Then, the CPU 901 compares the post-processing sheet time interval Tpd stored in the RAM 903 and the sheet discharge time interval Tp1 (=Ts) not corresponding to a break in “block circulation” (step S7), and if Tpd>Tp1 (=Ts) is obtained, the CPU 901 sets the circulation method to “alternate circulation” (step S10). On the other hand, if Tpd≦Tp1 (=Ts) is obtained, the CPU 901 proceeds to a step S8.

In the step S8, the CPU 901 compares the post-processing sheet bundle time interval Tbd stored in the RAM 903 and the sheet discharge time interval Tp2 (=Ts×(N+1)) corresponding to a break in “block circulation”, and if Tbd≧Tp2 (=Ts×(N+1)) is obtained, the CPU 901 sets the circulation method to “alternate circulation” (step S10). On the other hand, if Tbd<Tp2 (=Ts×(N+1)) is obtained, the CPU 901 sets the circulation method to “block circulation” (step S9). Then, the CPU 901 terminates the present circulation method selection process.

The circulation method set in the step S9 or S10 is stored in the RAM 903 before the present circulation method selection process is terminated. The image formation processing is sequentially performed according to the circulation method set as above.

In a mode in which post-processing is performed on sheets one by one as in the punch mode, the post-processing sheet time interval Tpd is required to be increased, and the post-processing sheet bundle time interval Tbd is equal to the post-processing sheet time interval Tpd. On the other hand, in a mode in which post-processing is performed for each one sheet bundle as in the case of the saddle stitching mode, the post-processing sheet bundle time interval Tbd is required to be increased, but the post-processing sheet time interval Tpd is not required to be increased.

When a print job is instructed which designates “A3” as the sheet size, “both-side” as print target side, “3 sheets×3 (sets)” as the number of print sheets, and “punch mode” as the post-processing mode, the CPU 901 calculates and sets the post-processing sheet time interval Tpd and the post-processing sheet bundle time interval Tbd as follows:

Tpd=Ts×1.3

Tbd=Tpd

On the other hand, when a print job is instructed which designates “A3” as the sheet size, “both-side” as print target side, 3 sheets×3 (sets) as the number of print sheets, and “saddle stitching mode” as the post-processing mode, the CPU 901 calculates and sets the post-processing sheet time interval Tpd and the post-processing sheet bundle time interval Tbd as follows:

Tpd=Ts

Tbd=Ts×3

When a print job designating the punch mode is instructed, Tpd>Tp1 is obtained in the determination in the step S7 of the circulation method selection process in FIG. 10, and hence the process proceeds from the step S7 to the step S10, wherein “alternate circulation” is set as the circulation method.

On the other hand, when a print job designating the saddle stitching mode is instructed, Tpd≦Tp1 is obtained in the determination in the step S7 of the circulation method selection process, and hence the process proceeds from the step S7 to the step S8. From the following equation:

$$\begin{matrix}Tp 2 = Ts \times ( N + 1 ) \\ = Ts \times 4\end{matrix}$$

Tbd<Tp2 is obtained in the step S8, and hence the process proceeds from the step S8 to the step S9, wherein “block circulation” is set as the circulation method.

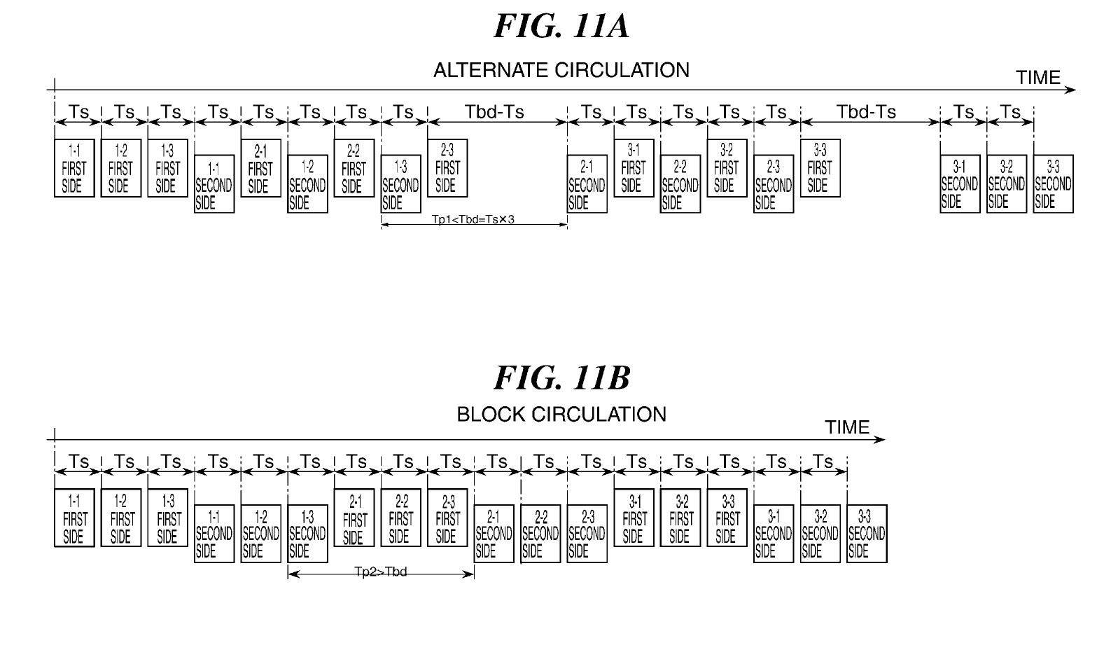

FIGS. 11A and 11B are diagrams each showing an example of a schedule for transferring toner images onto sheets by the transfer section 116 when the saddle stitching mode is designated. FIG. 11A shows a schedule set when “alternate circulation” is selected, and FIG. 11B shows a schedule set when “block circulation” is selected.

When “alternate circulation” is selected, as illustrated in FIG. 7A, the sheet conveyance-time interval from the sheet “1-3 (second side)” to the sheet “2-1 (second side)” is equal to only the sheet discharge time interval Tp (=2Ts). Therefore, it is required to cause the sheet “2-1 (second side)” to wait for a time corresponding to “Tbd-2Ts” by the roller 119, so as to make the sheet conveyance-time interval from the sheet “1-3 (second side)” equal to the post-processing sheet bundle time interval Tbd (=Ts×3), as illustrated in FIG. 11A. As a result, the sheet output productivity is lowered by a degree corresponding to the waiting time “Tbd-2Ts”.

In this case, in “block circulation”, as illustrated in FIG. 7B, the sheet conveyance-time interval from the sheet “1-3 (second side)” to the sheet “2-1 (second side)” is equal to the sheet discharge time interval Tp2 (=Ts×4), and the time “Ts×4” is larger than the post-processing sheet bundle time interval Tbd. Therefore, it is not necessary to cause the sheet “2-1 (second side)” to wait using the roller 119. In this print job, the sheet output productivity is improved in “block circulation” by a degree corresponding to the time. This provides the same effect of improvement of sheet output productivity as provided when the finisher capable of performing buffering of A3-size sheets buffers two A3-size sheets.

Note that in a case where the number of sheets forming one sheet bundle is indivisible by the number of circulated sheets N, the number of circulated sheets may be changed. Although in the present embodiment, the number of circulated sheets N is set to three sheets at the maximum, in a case, for example, where one set is formed by five sheets, the circulation of sheets may be performed by circulation of three sheets+circulation of two sheets. Further, in a case where one set is formed by four sheets, the circulation of sheets may be performed by circulation of two sheets+circulation of two sheets.

Alternatively, the circulation method may be selected such that “block circulation” is selected only when the number of sheets forming one set is divisible by the number of circulated sheets N, and “alternate circulation” is selected in the other cases.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2012-159601, filed Jul. 18, 2012, which is hereby incorporated by reference herein in its entirety.

What is claimed is:

1. An image forming apparatus comprising:
an accommodation unit configured to accommodate sheets;
an image forming unit configured to form an image on a sheet;
a conveying unit configured to convey a sheet from said accommodation unit to said image forming unit so as to form an image on a first side of the sheet, and to further convey the sheet on which the image has been formed on the first side to said image forming unit a second time so as to form an image also on a second side, which is different from the first side, of the sheet;
an acquisition unit configured to acquire information of post processing to be executed by a post-processing apparatus which is connectable to the image forming apparatus;
a control unit configured, in the case that images are to be formed on both of first and second sides of each of a plurality of sheets, to cause a double-sided image formation process to be executed by one of a first double-sided image formation process and a second doubled-sided image formation process, the first double-sided image formation process repeatedly performing continuous execution of image formation on the first side of each of a first predetermined number of sheets conveyed from said accommodation unit, and subsequent continuous execution of image formation on the second side of each of the first predetermined number of the conveyed sheets each having image formation performed on the first side thereof, and the second doubled-sided image formation process performing continuous execution of image formation on the first side of each of a second predetermined number of sheets conveyed from said accommodation unit, thereafter performing alternate execution of image formation on the second side of each of the conveyed sheets each having image formation performed on the first side thereof and image formation on a first side of each of different sheets conveyed from said accommodation unit, and thereafter performing continuous execution of image formation on the second side of each of the second predetermined number of sheets having image formation performed on the first side thereof; and
a selection unit configured, in the case that double-sided image formation processing is to be executed, to select one of the first double-sided image formation process and the second double-sided image formation process based on the information of post processing acquired by said acquisition unit.

2. The image forming apparatus according to claim 1, wherein said selection unit is configured to select one of the first double-sided image formation process and the second double-sided image formation process, based on a first sheet discharge time interval set when the first double-sided image formation process performs the continuous execution of image formation on the second side of each of the first predetermined number of sheets, a first post-processing time interval which is a time interval between sheets set when post processing is performed on a sheet-by-sheet basis, a second sheet discharge time interval between a last sheet of the first predetermined number of sheets and a first sheet of a next first predetermined number of sheets, and a second post-processing time interval which is a time interval between sheet bundles set when the post-processing is performed on each sheet bundle formed by a plurality of sheets.

3. The image forming apparatus according to claim 2, wherein said selection unit is configured to select the second double-sided image formation process when the first sheet discharge time interval is smaller than the first post-processing time interval.

4. The image forming apparatus according to claim 2, wherein said selection unit selects the first double-sided image formation process when the first post-processing time interval is not larger than the first sheet discharge time interval and the second sheet discharge time interval is larger than the second post-processing time interval, whereas when the first post-processing time interval is not larger than the first sheet discharge time interval and the second post-processing time interval is not smaller than the second sheet discharge time interval, said selection unit selects the second double-sided image formation process.

5. The image forming apparatus according to claim 1, wherein when the number of sheets forming one set is one, said selection unit selects the second double-sided image formation process.

6. The image forming apparatus according to claim 2, wherein said acquisition unit is configured to acquire the first post-processing time interval and the second post-processing time interval from the post-processing apparatus.

7. An image forming system comprising:
an accommodation unit configured to accommodate sheets;
an image forming unit configured to form an image on a sheet;
a conveying unit configured to convey a sheet from said accommodation unit to said image forming unit so as to form an image on a first side of the sheet, and to further convey the sheet on which the image has been formed on the first side to said image forming unit so as to form an image also on a second side, which is different from the first side, of the sheet;
a post-processing unit configured to perform post processing on a sheet on which an image has been formed by said image forming unit;
a control unit configured, in the case that images are to be formed on both of first and second sides of each of a plurality of sheets, to cause a double-sided image formation process to be executed by one of a first double-sided image formation process and a second doubled-sided image formation process, the first double-sided image formation process repeatedly performing continuous execution of image formation on the first side of each of a first predetermined number of sheets conveyed from said accommodation unit, and subsequent continuous execution of image formation on the second side of each of the first predetermined number of the conveyed sheets each having image formation performed on the first side thereof, and the second doubled-sided image formation process performing continuous execution of image formation on the first side of each of a second predetermined number of sheets conveyed from said accommodation unit, thereafter performing alternate execution of image formation on the second side of each of the conveyed sheets each having image formation performed on the first side thereof and image formation on a first side of each of different sheets conveyed from said accommodation unit, and finally performing continuous execution of image formation on the second side of each of the second predetermined number of sheets having image formation performed on the first side thereof; and
a selection unit configured, in the case that the double-sided image formation process is to be executed, to select one of the first double-sided image formation process and the second double-sided image formation process based on the information of post processing to be executed by said post-processing unit.

8. The image forming system according to claim 7, wherein said selection unit is configured to select one of the first double-sided image formation process and the second double-sided image formation process based on a first sheet discharge time interval set when the first double-sided image formation process performs the continuous execution of image formation on the second side of each of the first predetermined number of sheets, a first post-processing time interval which is a time interval between sheets set when post processing is performed on a sheet-by-sheet basis, a second sheet discharge time interval between a last sheet of the first predetermined number of sheets and a first sheet of a next first predetermined number of sheets, and a second post-processing time interval which is a time interval between sheet bundles set when the post-processing is performed on each sheet bundle formed by a plurality of sheets.

9. The image forming system according to claim 8, wherein said selection unit is configured to select the second double-sided image formation process when the first sheet discharge time interval is smaller than the first post-processing time interval.

10. The image forming system according to claim 8, wherein said selection unit is configured to select the first double-sided image formation process when the first post-processing time interval is not larger than the first sheet discharge time interval, and the second sheet discharge time interval is larger than the second post-processing time interval, whereas when the first post-processing time interval is not larger than the first sheet discharge time interval, and the second post-processing time interval is not smaller than the second sheet discharge time interval, said selection unit selects the second double-sided image formation process.

11. The image forming system according to claim 7, wherein when the number of sheets forming one set is one, said selection unit selects the second double-sided image formation process.
